(19) United States
(12) Patent Application Publication
(10) Pub. No.: US 2026/0335803 A1
(43) Pub. Date: Oct. 29, 2026

(54) PURIFICATION DEVICE, FILTER UNIT, AND PRODUCTION METHOD FOR PURIFICATION DEVICE

(71) Applicant: SEIKO EPSON CORPORATION, Tokyo (JP)

(72) Inventors: Akira ANAMI, KITAKYUSHU-SHI (JP); Manabu WATABE, SHIOJIRI-SHI (JP); Hiroshi TANAKA, MATSUMOTO-SHI (JP); Tomoaki YAMAZAKI, SHIOJIRI-SHI (JP)

(21) Appl. No.: 19/654,726

(22) Filed: Apr. 22, 2026

(30) Foreign Application Priority Data
Apr. 24, 2025 (JP) 2025-072687

(51) Int. Cl. B01D 46/00; B01D 46/24

(52) U.S. Cl. CPC B01D 46/0005; B01D 46/2403; B01D 2201/40; B01D 2275/201

(57) ABSTRACT

A purification device includes a housing including a first suction chamber and a second suction chamber, a filter unit including a plurality of filter members formed in a cylindrical shape and a support member that is in close contact with and supports outer circumferential portions of the filter members, the filter unit being detachably installed in the housing, a rail section configured to guide the support member when the filter unit is installed in the housing and when the filter unit is detached from the housing, and an airflow generation section configured to generate an airflow that causes air in the first suction chamber to flow to the second suction chamber side via the filter members. The filter unit partitions the first suction chamber and the second suction chamber in a mounted state in which the filter unit is installed in the housing.

### CROSS-REFERENCE TO RELATED APPLICATIONS

The present application is based on, and claims priority from JP Application Serial Number 2025-072687, filed Apr. 24, 2025, the disclosure of which is hereby incorporated by reference herein in its entirety.

### BACKGROUND

### 1. Technical Field

The present disclosure relates to a purification device, a filter unit, and a production method for a purification device.

### 2. Related Art

For example, as disclosed in JP-A-2024-117949, a dust collector including a filter for gathering powder dust is known. The dust collector includes a housing including an inlet for introducing waste powder and air and an exhaust port for discharging the air and a filter provided in the housing. Of the waste powder and the air introduced into the housing, the waste powder cannot pass through the filter and drops and is accumulated at the bottom of the housing and the air passes through the filter and is discharged from the exhaust port.

JP-A-2024-117949 is an example of the related art.

However, in the dust collector described in JP-A-2024-117949, it is necessary to perform maintenance work such as cleaning or replacement for the filter. However, no measures have been taken to quickly and easily perform the maintenance work.

### SUMMARY

According to an aspect of the present disclosure, there is provided a purification device including: a housing including a first suction chamber and a second suction chamber; a filter unit including a plurality of filter members formed in a cylindrical shape and a support member that is in close contact with and supports outer circumferential portions of the filter members, the filter unit being detachably installed in the housing; a rail section configured to guide the support member when the filter unit is installed in the housing and when the filter unit is detached from the housing; and an airflow generation section configured to generate an airflow that causes air in the first suction chamber to flow to the second suction chamber side via the filter members, wherein the filter unit partitions the first suction chamber and the second suction chamber in a mounted state in which the filter unit is installed in the housing.

According to an aspect of the present disclosure, there is provided a filter unit detachably installed in a housing of a purification device including: the housing including a first suction chamber and a second suction chamber; a rail section provided in the housing; and an airflow generation section configured to generate an airflow that causes air in the first suction chamber to flow to the second suction chamber side, the filter unit including: a plurality of filter members formed in a cylindrical shape; and a support member that is in close contact with and supports outer circumferential portions of the filter members, wherein the filter unit partitions the first suction chamber and the second suction chamber in a mounted state in which the filter unit is installed in the housing.

According to an aspect of the present disclosure, there is provided a production method of producing a purification device cleaned by cleaning the purification device including: a housing including a first suction chamber and a second suction chamber; a filter unit including a plurality of filter members formed in a cylindrical shape and a support member that is in close contact with and supports outer circumferential portions of the filter members, the filter unit being detachably installed in the housing; a rail section configured to guide the support member when the filter unit is installed in the housing and when the filter unit is detached from the housing; and an airflow generation section configured to generate an airflow that causes air in the first suction chamber to flow to the second suction chamber side via the filter members, the filter unit partitioning the first suction chamber and the second suction chamber in a mounted state in which the filter unit is installed in the housing, the production method including: a first step of taking out, along the rail section, the filter unit to which foreign matters adhere; a second step of cleaning the taken-out filter unit; and a third step of inserting the cleaned filter unit along the rail section and mounting the filter unit in the housing.

### BRIEF DESCRIPTION OF THE DRAWINGS

FIG. 1 is a configuration diagram schematically illustrating a fibrous body manufacturing apparatus including a purification device according to an embodiment of the present disclosure.

FIG. 2 is a perspective view of the purification device illustrated in FIG. 1.

FIG. 3 is a perspective view of the purification device illustrated in FIG. 1 and is a diagram illustrating a state in which a filter unit is detached from a housing.

FIG. 4 is a cross-sectional view taken along a line A-A in FIG. 2.

FIG. 5 is a perspective view of the purification device illustrated in FIG. 1 and is a diagram at an angle of looking through a window section.

FIG. 6 is a side view of the filter unit illustrated in FIG. 2 and is a diagram illustrating a state in which a support member is guided by a rail section.

FIG. 7 is a side view of the filter unit illustrated in FIG. 2 and is a diagram illustrating the state in which the support member is guided by the rail section.

FIG. 8 is a side view of the filter unit illustrated in FIG. 2 and is a diagram illustrating a state in which insertion of the support member is completed.

FIG. 9 is an enlarged perspective view illustrating a state in which the support member is inserted.

FIG. 10 is an enlarged perspective view illustrating the state in which the support member is inserted.

FIG. 11 is a side view illustrating the state in which the support member is inserted and is a diagram illustrating a state immediately before the insertion is completed.

FIG. 12 is a diagram illustrating the state in which the insertion of the support member is completed.

### DESCRIPTION OF EMBODIMENTS

Hereinafter, a purification device, a filter unit, and a production method for a purification device of the present disclosure are explained in detail based on a preferred embodiment illustrated in the accompanying drawings.

### Embodiment

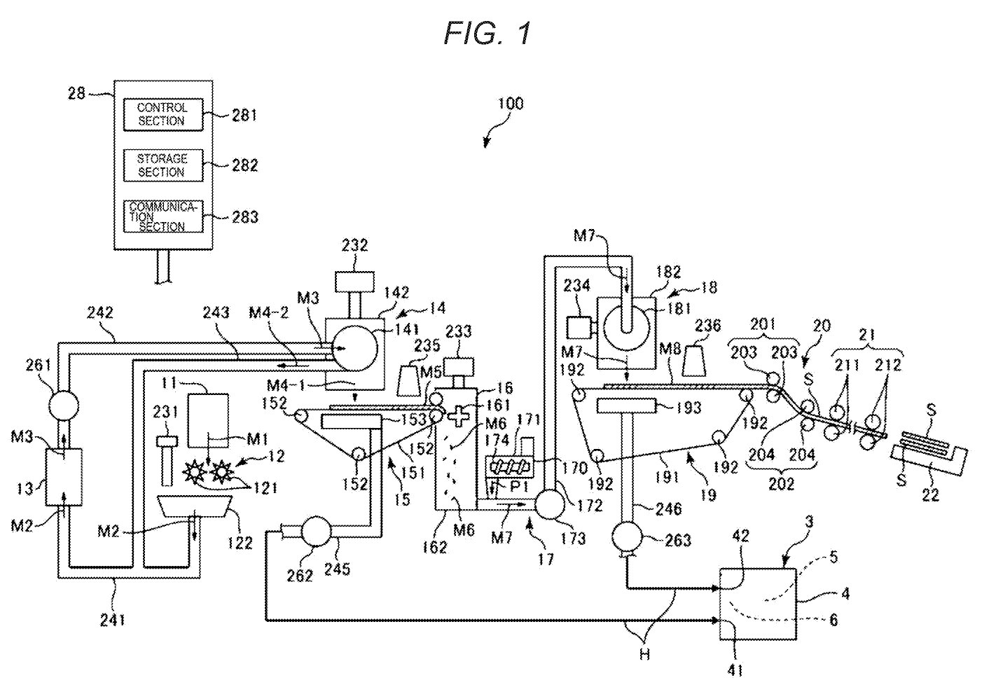

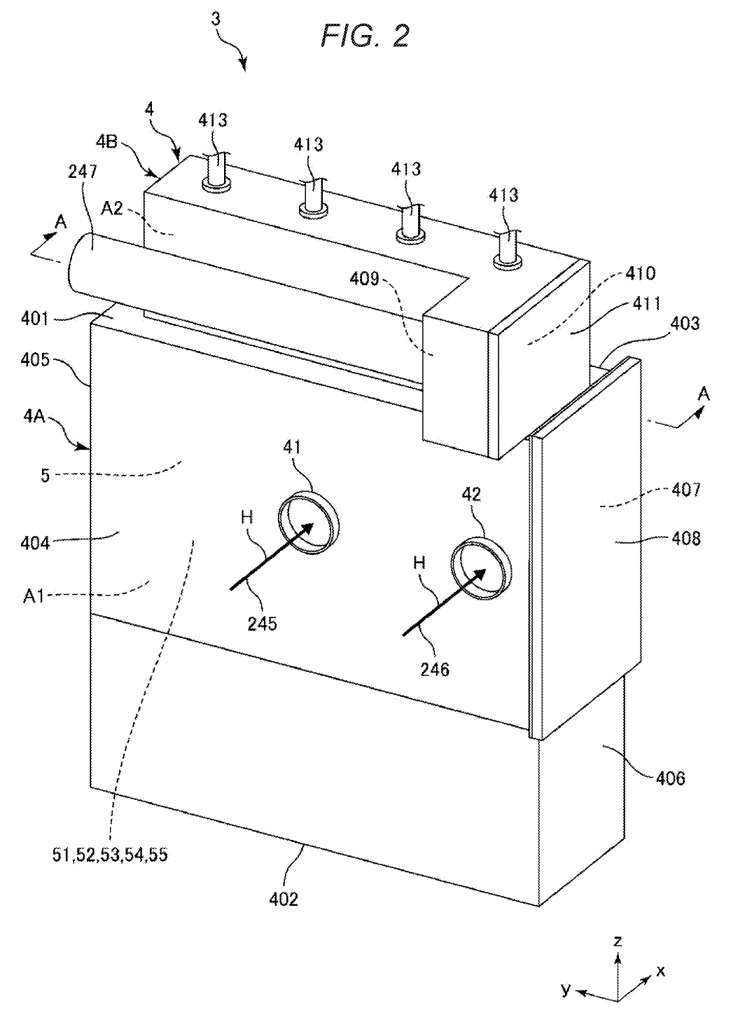

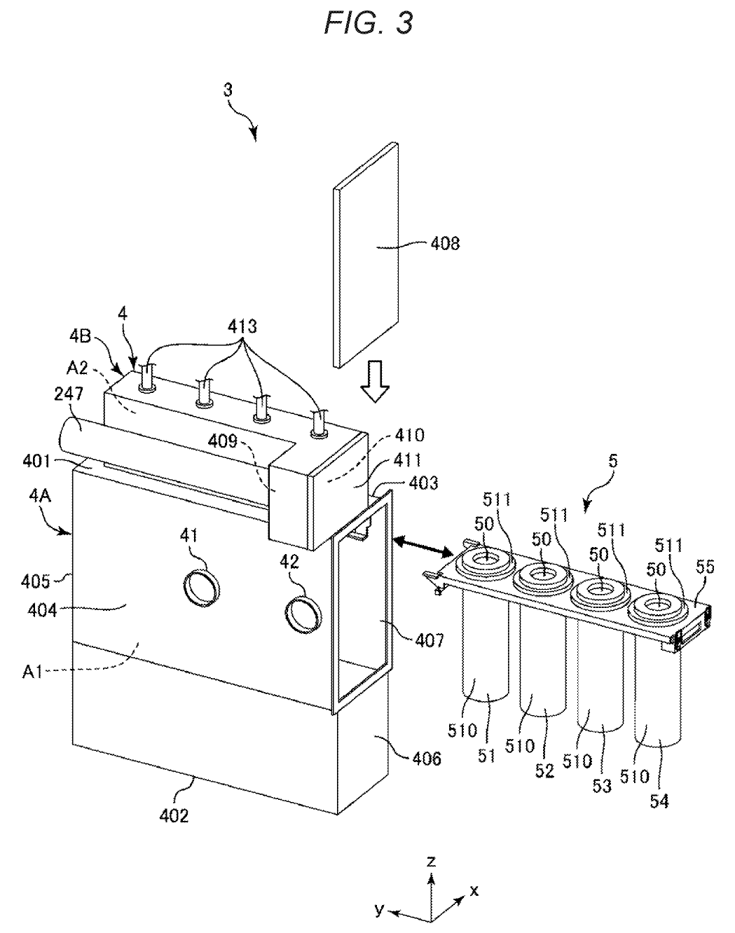

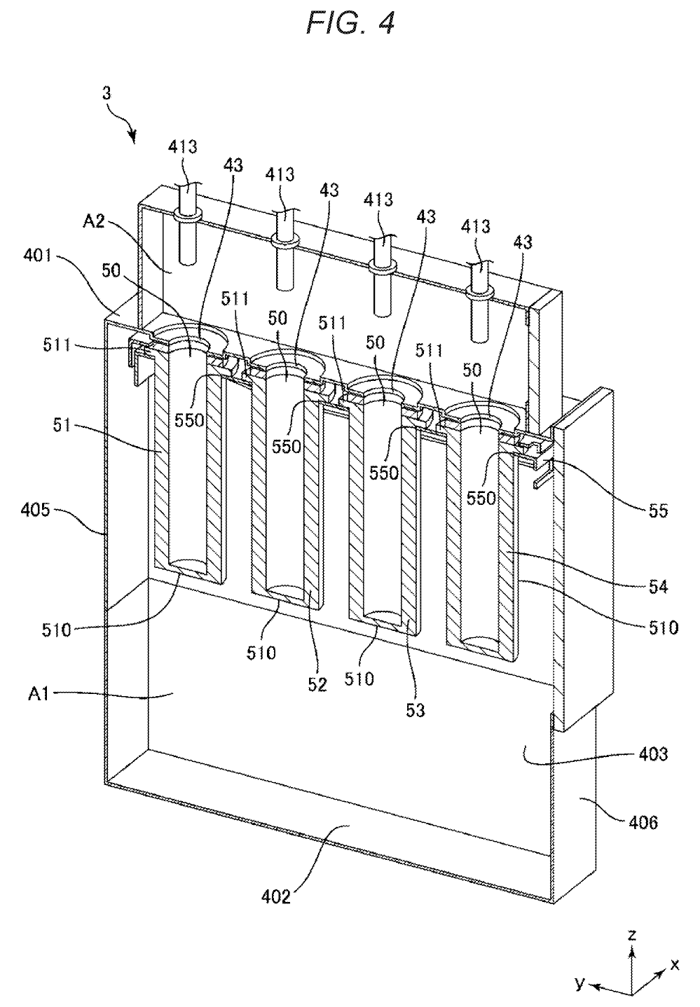

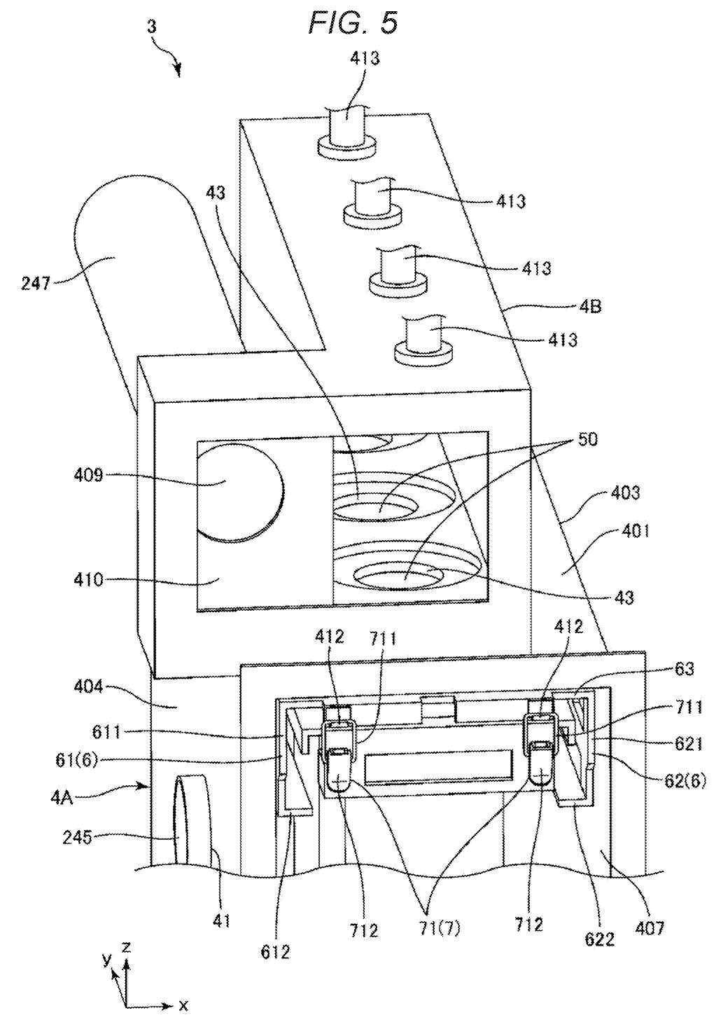

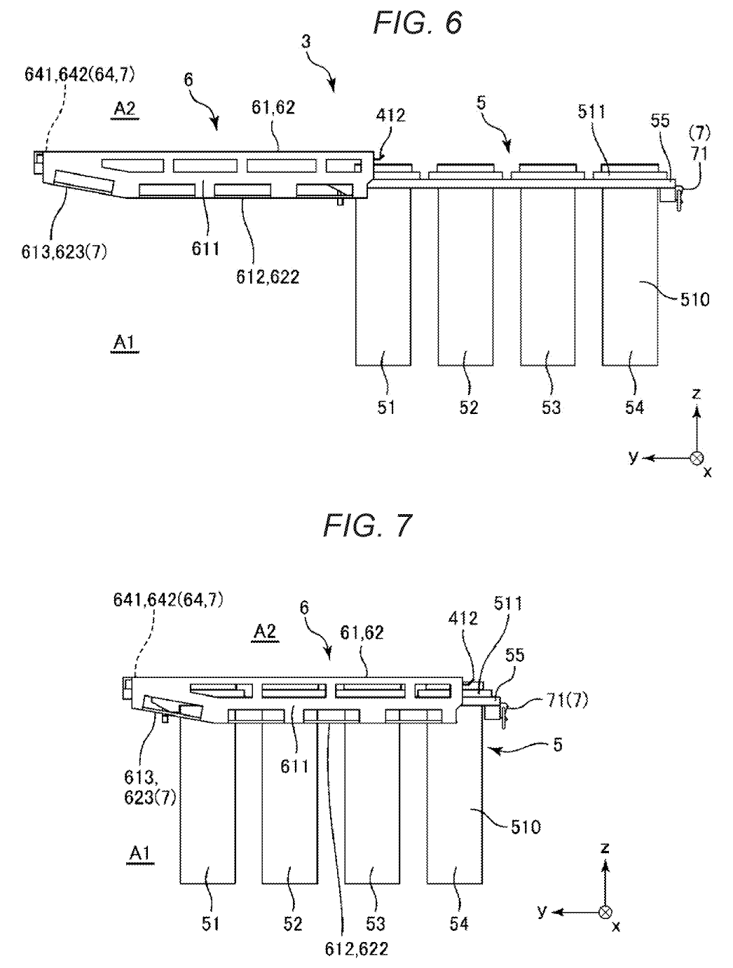

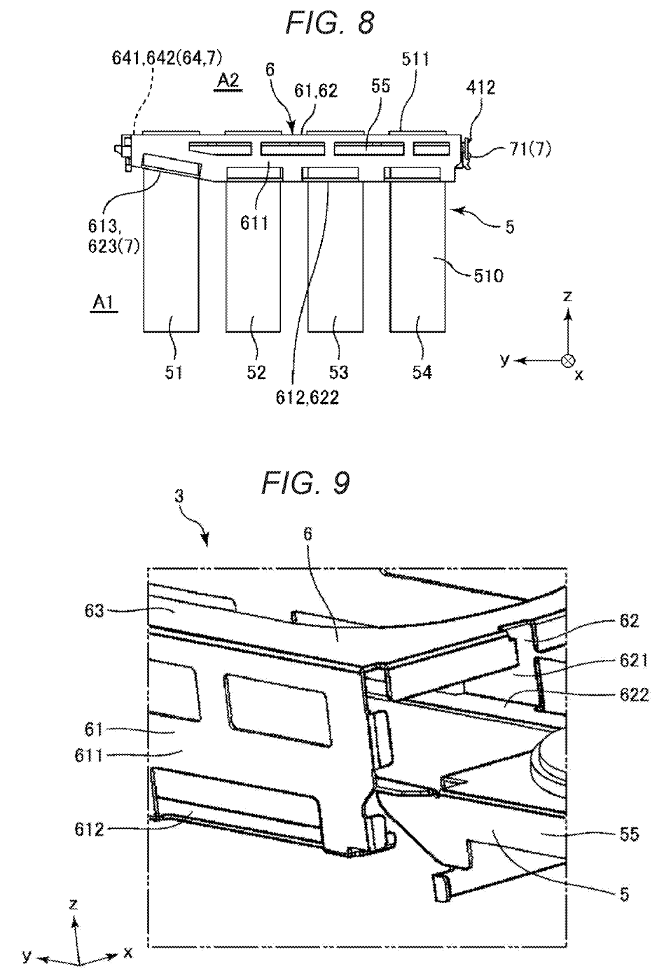

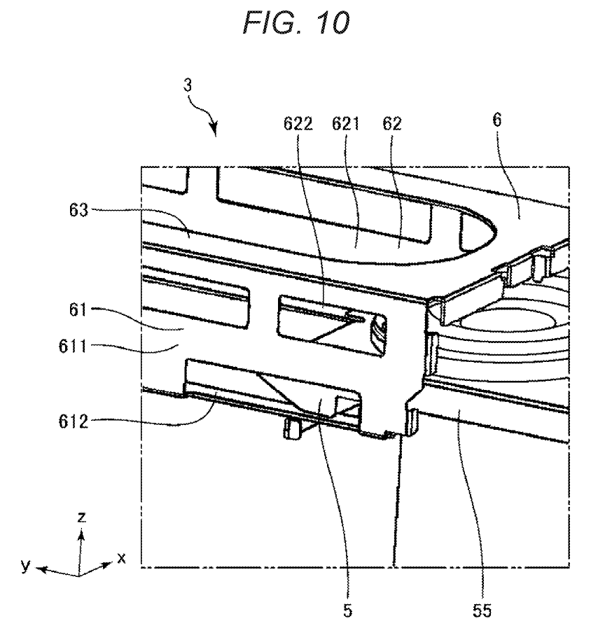

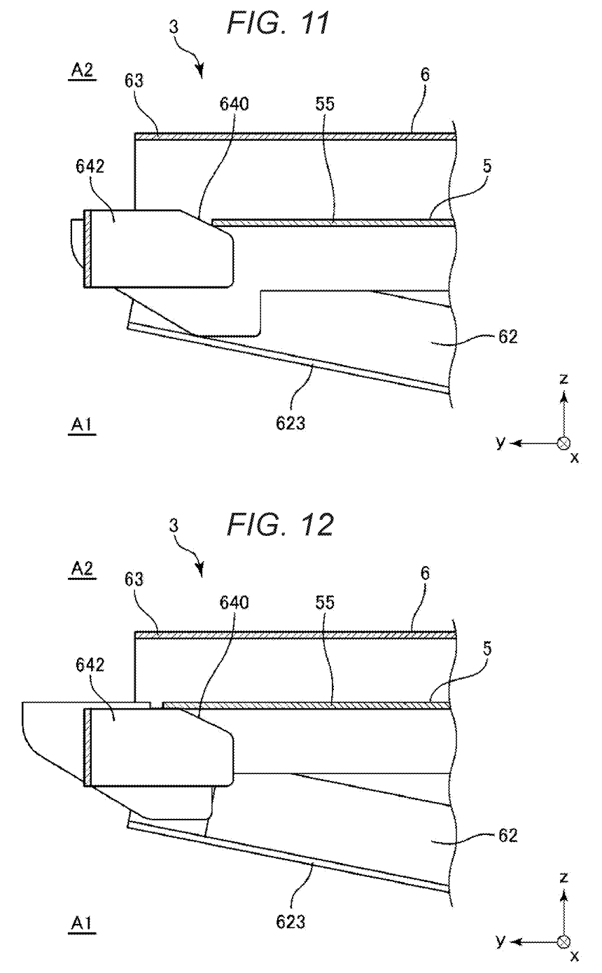

FIG. 1 is a configuration diagram illustrating an overview of a fibrous body manufacturing apparatus including a purification device according to an embodiment of the present disclosure. FIG. 2 is a perspective view of the purification device illustrated in FIG. 1. FIG. 3 is a perspective view of the purification device illustrated in FIG. 1 and is a diagram illustrating a state in which a filter unit is detached from a housing. FIG. 4 is a cross-sectional view taken along a line A-A in FIG. 2. FIG. 5 is a perspective view of the purification device illustrated in FIG. 1 and is a diagram at an angle of looking through a window section. FIG. 6 is a side view of the filter unit illustrated in FIG. 2 and is a diagram illustrating a state in which a support member is guided by a rail section. FIG. 7 is a side view of the filter unit illustrated in FIG. 2 and is a diagram illustrating the state in which the support member is guided by the rail section. FIG. 8 is a side view of the filter unit illustrated in FIG. 2 and is a diagram illustrating a state in which insertion of the support member is completed. FIG. 9 is an enlarged perspective view illustrating a state in which the support member is inserted. FIG. 10 is an enlarged perspective view illustrating the state in which the support member is inserted. FIG. 11 is a side view illustrating the state in which the support member is inserted and is a diagram illustrating a state immediately before the insertion is completed. FIG. 12 is a diagram illustrating the state in which the insertion of the support member is completed.

Hereinafter, an upper side (a +z-axis side) in FIGS. 2-12 is sometimes referred to as "upper" or "above" and a lower side (a -z-axis side) is sometimes referred to as "lower" or "below". Note that, in FIGS. 2-12, an x-axis, a y-axis, and a z-axis orthogonal to one another are illustrated. The z axis is an axis extending in the vertical direction. FIG. 1 is a schematic configuration diagram. Positional relationships, directions, sizes, and the like of sections of a fibrous body manufacturing apparatus 100 are not limited to illustrated ones.

In FIG. 1, a direction in which a coarsely crushed piece M2, a defibrated material M3, a first sorted material M4-1, a second sorted material M4-2, a first web M5, subdivided bodies M6, a mixture M7, a second web M8, and a sheet S are conveyed, that is, a direction indicated by an arrow is also referred to as conveyance direction. A distal end side of an arrow in FIG. 1 is also referred to as "downstream" in the conveyance direction and a proximal end side of the arrow in FIG. 1 is also referred to as "upstream" in the conveyance direction.

The fibrous body manufacturing apparatus 100 illustrated in FIG. 1 is a fibrous body manufacturing apparatus that manufactures the sheet S, which is an example of a fibrous body, from a raw material M1, which is waste paper such as used copy paper.

The fibrous body manufactured by the fibrous body manufacturing apparatus 100 is not limited to the sheet S and may be, for example, a fibrous body having a block shape, a cup shape, a rod shape, a cylindrical shape, an annular shape, a frame shape, or another irregular shape. The shape and the structure of the fibrous body depend on a configuration of a molding section 20 explained below.

As illustrated in FIG. 1, the fibrous body manufacturing apparatus 100 includes a raw material supply section 11, a coarsely crushing section 12, a defibrating section 13, a sorting section 14, a first web forming section 15, a subdividing section 16, a mixing section 17, a dispersing section 18, a second web forming section 19, a molding section 20, a cutting section 21, a stock section 22, and a purification device 3, which is an example of the purification device of the present disclosure.

The fibrous body manufacturing apparatus 100 includes a humidifying section 231, a humidifying section 232, a humidifying section 233, a humidifying section 234, a humidifying section 235, and a humidifying section 236. Besides, the fibrous body manufacturing apparatus 100 includes a blower 261, a blower 262, and a blower 263.

In the fibrous body manufacturing apparatus 100, a raw material supplying step, a coarsely crushing step, a defibrating step, a sorting step, a first web forming step, a dividing step, a mixing step, a loosening step, a second web forming step, a sheet forming step, and a cutting step are executed in this order.

Hereinafter, configurations of the sections are explained.

The raw material supplying section 11 is a portion that performs the raw material supplying step of supplying the raw material M1 to the coarsely crushing section 12. The raw material M1 is a sheet-shaped material made of a fiber-containing material containing cellulose fibers. The raw material M1 may be in any form such as waste paper, woven fabric, or nonwoven fabric.

The coarsely crushing section 12 is a portion that performs the coarsely crushing step of coarsely crushing, in air such as the atmosphere, the raw material M1 supplied from the raw material supplying section 11. The coarsely crushing section 12 includes a pair of coarsely crushing blades 121 and a chute 122.

The pair of coarsely crushing blades 121 can coarsely crush the raw material M1 therebetween, that is, cut the raw material M1 into the coarsely crushed piece M2 by rotating in opposite directions to each other. The shape and the size of the coarsely crushed piece M2 are not particularly limited if the shape and the size are suitable for defibrating processing in the defibrating section 13. Examples of the shape of the coarsely crushed piece M2 include small pieces having a square shape as a plane shape and small pieces having a rectangular shape, in particular, a strip-shaped shape. The coarsely crushed piece M2 is, for example, preferably small pieces having an average length of one side of 100mm or less and more preferably small pieces having an average length of one side of 3mm or more and 70mm or less. The shape of the small pieces may be a shape other than the square or the rectangle. The thickness of the small pieces is preferably 0.07mm or more and 0.10mm or less.

The chute 122 is disposed below the pair of coarsely crushing blades 121 and is formed in, for example, a conical shape or a funnel shape. Accordingly, the chute 122 can receive the coarsely crushed piece M2 that is coarsely crushed by the coarsely crushing blades 121 and falls.

Above the chute 122, the humidifying section 231 is disposed adjacent to the pair of coarsely crushing blades 121. The humidifying section 231 humidifies the coarsely crushed piece M2 in the chute 122. The humidifying section 231 includes a vaporization-type humidifier that includes a not-illustrated filter containing moisture and causes air to pass through the filter to thereby supply humidified air with increased humidity to the coarsely crushed piece M2. Since the humidified air is supplied to the coarsely crushed piece M2, it is possible to prevent the coarsely crushed piece M2 from adhering to the chute 122 with an electrostatic force.

The chute 122 is coupled to the defibrating section 13. The coarsely crushed piece M2 collected by the chute 122 is sent to the defibrating section 13.

The defibrating section 13 is a portion that performs the defibrating step of defibrating the coarsely crushed piece M2 in the air, that is, in a dry manner. The defibrated material M3 can be generated from the coarsely crushed piece M2 by the defibrating processing in the defibrating section 13. Here, "defibrating" means loosening the coarsely crushed piece M2, which is formed by binding a plurality of fibers, into each one of fibers. An object obtained by the loosening becomes the defibrated material M3. The shape of the defibrated material M3 is a linear shape or a band shape. Defibrated materials M3 may be present in a state of being entangled with one another to form a mass, that is, in a state of forming a so-called "lump".

The defibrating section 13 can generate, with rotation of a not-illustrated rotor, a flow of air toward the sorting section 14, that is, an airflow. Accordingly, the coarsely crushed piece M2 can be introduced from a pipe 241 to upstream of the defibrating section 13 and, after the defibrating processing, the defibrated material M3 can be delivered to the sorting section 14 via a pipe 242.

The pipe 242 is coupled to downstream of the defibrating section 13. The blower 261 including, for example, a turbo-type fan is installed halfway in the pipe 242. The blower 261 is an airflow generation device that generates an airflow flowing to the sorting section 14. Accordingly, the introduction of the coarsely crushed piece M2 into the defibrating section 13 and the delivery of the defibrated material M3 to the sorting section 14 are promoted. In the defibrating section 13, the passage and the defibrating processing for the coarsely crushed piece M2, which is the raw material, are smoothly performed because of the structure of the defibrating section 13. However, the passage and the defibration processing for the coarsely crushed piece M2 in the defibrating section 13 are promoted by an operation of the blower 261 installed downstream of the defibrating section 13. The blower 261 may be installed upstream of the defibrating section 13.

The sorting section 14 is a portion that performs the sorting step of sorting the defibrated material M3 according to a fiber length. In the sorting section 14, the defibrated material M3 is sorted into a first sorted material M4-1 and a second sorted material M4-2 having a larger fiber length than the first sorted material M4-1. The first sorted material M4-1 is an object having a size suitable for manufacturing the sheet S thereafter. On the other hand, the second sorted material M4-2 includes, for example, an insufficiently defibrated object and an object obtained by defibrated fibers being excessively aggregated with one another.

The sorting section 14 includes a drum section 141 and a housing section 142 that houses the drum section 141.

The drum section 141 is a sieve that includes a net body formed in a cylindrical shape and rotates around the center axis thereof. The defibrated material M3 flows into the drum section 141. The drum section 141 rotates, whereby the defibrated material M3 smaller than a mesh opening is sorted as the first sorted material M4-1 and the defibrated material M3 having a size equal to or larger than the mesh opening is sorted as the second sorted material M4-2.

The first sorted material M4-1 falls from the drum section 141.

On the other hand, the second sorted material M4-2 is delivered to a pipe 243 coupled to the drum section 141. An end portion of the pipe 243 on the side opposite to, that is, downstream of the drum section 141 is coupled halfway in the pipe 241. The second sorted material M4-2 having passed through the pipe 243 merges with the coarsely crushed piece M2 in the pipe 241 and flows into the defibrating section 13 together with the coarsely crushed piece M2. Accordingly, the second sorted material M4-2 is returned to the defibrating section 13 and is subjected to the defibrating processing together with the coarsely crushed piece M2.

The first sorted material M4-1 having fallen from the drum section 141 falls while being dispersed in the air and moves toward the first web forming section 15 located below the drum section 141. The first web forming section 15 is a portion that performs the first web forming step of forming the first web M5 from the first sorted material M4-1. The first web forming section 15 includes a mesh belt 151, three tension rollers 152, and a suction section 153.

The mesh belt 151 is an endless belt on which the first sorted material M4-1 is deposited. This mesh belt 151 is wound around the three tension rollers 152. Then, the first sorted material M4-1 on the mesh belt 151 is conveyed downstream by rotational drive of the tension rollers 152.

The first sorted material M4-1 has a size equal to or larger than the opening of the mesh belt 151. Accordingly, the first sorted material M4-1 is restricted from passing through the mesh belt 151 and, thus, can be deposited on the mesh belt 151. Since the first sorted material M4-1 is conveyed downstream together with the mesh belt 151 while being deposited on the mesh belt 151, the first sorted material M4-1 is formed as the first web M5.

Objects not suitable to be sent downstream, for example, foreign matters such as dust and dirt, paper powder, and cut pieces of fibers are sometimes mixed in the first sorted material M4-1. These dust, dirt, paper powder, cut pieces of fibers, and the like are collectively referred to as waste powder. For example, the waste powder sometimes adheres to the raw material M1 or is sometimes caused by coarse crushing in the coarsely crushing section 12 or defibration in the defibrating section 13. Then, powder H formed by such waste powder is sorted out of the first sorted material M4-1 in the first web forming section 15 and is gathered and collected by the purification device 3 explained below. By sorting and removing the waste powder out of the first sorted material M4-1, it is possible to improve the quality of the manufactured sheet S.

The suction section 153 is a suction mechanism that sucks air from below the mesh belt 151. Accordingly, the powder H having passed through the mesh belt 151 can be sucked together with the air.

The suction section 153 is coupled to the purification device 3 via a pipe 245. The powder H, which is the waste powder, sucked by the suction section 153 is collected in the purification device 3 through the pipe 245.

The blower 262 is installed halfway in the pipe 245. A suction force can be generated in the suction section 153 by an operation of the blower 262. Accordingly, the formation of the first web M5 on the mesh belt 151 is promoted. The powder H is removed from the first web M5 and the quality of a material of the first web M5 is improved. The powder H is transferred to the purification device 3 through the pipe 245 and collected by the operation of the blower 262. The blower 262 is an airflow generation section that generates an airflow that causes air in the first suction chamber A1 to flow to the second suction chamber A2 side via the filter members 51 to 54 as explained below.

The housing section 142 is coupled to the humidifying section 232. The humidifying section 232 includes a vaporization-type humidifier. Accordingly, humidified air is supplied into the housing section 142. The first sorted material M4-1 can be humidified by the humidified air and, thus, it is possible to prevent the first sorted material M4-1 from adhering to the inner wall of the housing section 142 with an electrostatic force.

The humidifying section 235 is disposed downstream of the sorting section 14. Accordingly, moisture can be supplied to the first web M5 and, thus, a moisture content of the first web M5 is adjusted. Attraction of the first web M5 to the mesh belt 151 by an electrostatic force can be prevented by the adjustment. Accordingly, the first web M5 is easily peeled off from the mesh belt 151 at positions where the mesh belt 151 is folded back by the tension rollers 152.

The subdividing section 16 is disposed downstream of the humidifying section 235. The subdividing section 16 is a portion that performs the dividing step of dividing the first web M5 peeled off from the mesh belt 151. The subdividing section 16 includes a rotatably supported propeller 161 and a housing section 162 that houses the propeller 161. The first web M5 can be divided by the rotating propeller 161. The divided first web M5 becomes the subdivided bodies M6. The subdivided bodies M6 descend in the housing section 162.

The housing section 162 is coupled to the humidifying section 233. The humidifying section 233 includes a vaporization-type humidifier. Accordingly, humidified air is supplied into the housing section 162. It is possible to prevent, with the humidified air, the subdivided bodies M6 from adhering to the propeller 161 and the inner wall of the housing section 162 with an electrostatic force.

The mixing section 17 is disposed downstream of the subdividing section 16. The mixing section 17 is a portion that performs the mixing step of mixing the subdivided bodies M6 and an additive. The mixing section 17 includes an additive supplying section 171, a pipe 172, and a blower 173.

The pipe 172 connects the housing section 162 of the subdividing section 16 and a housing 182 of the dispersing section 18 and is a flow path through which the mixture M7 of the subdivided bodies M6 and the additive passes.

The additive supplying section 171 is coupled halfway in the pipe 172. The additive supplying section 171 includes a housing section 170 in which the additive is stored and a screw feeder 174 provided in the housing section 170. By rotation of the screw feeder 174, the additive in the housing section 170 is pushed out from the housing section 170 and supplied into the pipe 172. The additive supplied into the pipe 172 is mixed with the subdivided bodies M6 to be the mixture M7.

Here, examples of the additive supplied from the additive supplying section 171 include a binder for binding fibers to one another, a coloring agent for coloring the fibers, an aggregation inhibitor for inhibiting aggregation of the fibers, a flame retardant for making the fibers and the like difficult to burn, and a paper strengthening agent for strengthening paper strength of the sheet S. One kind or a plurality of kinds of these additives can be used in combination. Hereinafter, as an example, a case in which the additive is a binder P1 is explained. Since the additive contains the binder P1 for binding the fibers to one another, the strength of the sheet S can be increased.

The blower 173 is installed further downstream than the additive supplying section 171 halfway in the pipe 172. The mixing of the subdivided bodies M6 and the binder P1 is promoted by the action of a rotating section such as blades of the blower 173. The blower 173 can generate an airflow flowing toward the dispersing section 18. The subdivided bodies M6 and the binder P1 can be stirred in the pipe 172 by the airflow. Accordingly, the mixture M7 is conveyed to the dispersing section 18 in a state in which the subdivided bodies M6 and the binder P1 are uniformly dispersed. The subdivided bodies M6 in the mixture M7 are loosened in a process of passing through the pipe 172 and change to a finer fibrous state.

The blower 173 is electrically coupled to the control device 28 and an operation thereof is controlled. An amount of air sent into the drum 181 can be adjusted by controlling an airflow rate of the blower 173.

Although not illustrated, the end portion on the drum 181 side of the pipe 172 is bifurcated. The bifurcated end portions are respectively coupled to not-illustrated inlets formed in the end face of the drum 181.

The dispersing section 18 illustrated in FIG. 1 is a portion that performs the loosening step of loosening and discharging fibers entangled with one another in the mixture M7. The dispersing section 18 includes the drum 181 that introduces and discharges the mixture M7, which is the defibrated material, and the housing 182 that houses the drum 181.

The drum 181 is a sieve that includes a net body formed in a cylindrical shape and rotates around the center axis thereof. The drum 181 rotates, whereby fibers and the like smaller than a mesh opening in the mixture M7 can pass through the drum 181. At this time, the mixture M7 is loosened and discharged together with the air. That is, the drum 181 functions as a discharge section that discharges a material containing fibers.

The drum 181 is coupled to a not-illustrated drive source and is rotated by a rotational force output from the drive source. The drive source is electrically coupled to the control device 28 and an operation thereof is controlled.

The housing 182 is coupled to the humidifying section 234. The humidifying section 234 includes a vaporization-type humidifier. Accordingly, humidified air is supplied into the housing 182. The inside of the housing 182 can be humidified by the humidified air. Thus, it is possible to prevent the mixture M7 from adhering to the inner wall of the housing 182 with an electrostatic force.

The mixture M7 discharged from the drum 181 falls while being dispersed in the air and moves to the second web forming section 19 located below the drum 181. The second web forming section 19 is a portion that performs the second web forming step of forming the second web M8, which is a deposit, by depositing the mixture M7. The second web forming section 19 includes a mesh belt 191, tension rollers 192, and a suction section 193.

The mesh belt 191 is a mesh member and includes an endless belt in the illustrated configuration. The mixture M7 dispersed and discharged by the dispersing section 18 is deposited on the mesh belt 191. The mesh belt 191 is wound around the four tension rollers 192. The mixture M7 on the mesh belt 191 is conveyed downstream by rotational drive of the tension rollers 192.

In the illustrated configuration, the mesh belt 191 is used as an example of a mesh member. However, the mesh member is not limited thereto in the present disclosure and may be, for example, a mesh member formed in a flat plate shape.

Most of the mixture M7 on the mesh belt 191 has a size equal to or larger than an opening of the mesh belt 191. Accordingly, the mixture M7 is restricted from passing through the mesh belt 191 and, thus, can be deposited on the mesh belt 191. Since the mixture M7 is conveyed downstream together with the mesh belt 191 while being deposited on the mesh belt 191, the mixture M7 is formed as the second web M8.

Waste powder is sometimes mixed in the mixture M7. The waste powder is sometimes caused by, for example, stirring, mixing, or loosening in the subdividing section 16, the mixing section 17, and the dispersing section 18. Waste powder that cannot be entirely removed from the first sorted material M4-1 in the first web forming section 15 sometimes remains in the mixture M7. The powder H formed by such waste powder is sorted out of the mixture M7 in the second web forming section 19 and is gathered and collected by the purification device 3 explained below. By sorting and removing the waste powder out of the mixture M7, the quality of the manufactured sheet S can be improved.

The suction section 193 is a suction mechanism that sucks air from below the mesh belt 191. Accordingly, the mixture M7 can be sucked onto the mesh belt 191. Thus, the deposit of the mixture M7 on the mesh belt 191 is promoted.

The suction section 193 is coupled to the purification device 3 via a pipe 246. The powder H, which is the waste powder, sucked by the suction section 193 is collected in the purification device 3 through the pipe 246.

The blower 263 is installed halfway in the pipe 246. A suction force can be generated in the suction section 193 by an operation of the blower 263. Accordingly, the formation of the second web M8 on the mesh belt 191 is promoted. The powder H is removed from the second web M8 and the quality of the material of the second web M8 is improved. The powder H is transferred to the purification device 3 through the pipe 246 and collected by the operation of the blower 263.

The blower 263 is an airflow generation section that generates an airflow that causes the air in the first suction chamber A1 to flow to the second suction chamber A2 side via the filter members 51 to 54 as explained below.

The humidifying section 236 is disposed downstream of the dispersing section 18. Accordingly, moisture can be supplied to the second web M8. Thus, a moisture content of the second web M8 is adjusted. Attraction of the second web M8 to the mesh belt 191 by an electrostatic force can be prevented by the adjustment. Accordingly, the second web M8 is easily peeled off from the mesh belt 191 at positions where the mesh belt 191 is folded back by the tension rollers 192.

The molding section 20 is disposed downstream of the second web forming section 19. The molding section 20 is a portion that performs the sheet forming step of forming the sheet S, which is a fibrous body, from the second web M8. The molding section 20 includes a pressurizing section 201 and a heating section 202.

The pressurizing section 201 includes a pair of calender rollers 203 and can pressurize the second web M8 between the calender rollers 203 without heating the second web M8. Accordingly, the density of the second web M8 is increased. A degree of the heating when heating the second web M8 is preferably, for example, a degree of not melting the binder P1. The second web M8 is conveyed toward the heating section 202. One of the pair of calender rollers 203 is a driving roller driven by an operation of a not-illustrated motor and the other is a driven roller.

The heating section 202 includes a pair of heating rollers 204 and can pressurize the second web M8 while heating the second web M8 between the heating rollers 204. By the heating and the pressurizing, in the second web M8, the binder P1 is melted and fibers are bonded to one another via the melted binder P1. Accordingly, the sheet S is formed. The sheet S is conveyed toward the cutting section 21. One of the pair of heating rollers 204 is a driving roller driven by an operation of a not-illustrated motor and the other is a driven roller.

The cutting section 21 is disposed downstream of the molding section 20. The cutting section 21 is a portion that performs the cutting step of cutting the sheet S. The cutting section 21 includes a first cutter 211 and a second cutter 212.

The first cutter 211 cuts the sheet S in a direction intersecting a conveyance direction of the sheet S, in particular, in a direction orthogonal to the conveyance direction.

The second cutter 212 cuts the sheet S, downstream of the first cutter 211, in a direction parallel to the conveyance direction of the sheet S. The cutting is to remove unnecessary portions at both side end portions in the width direction of the sheet S and adjust the width of the sheet S.

By cutting the sheet S with the first cutter 211 and the second cutter 212 as explained above, the sheet S having a desired shape and a desired size can be obtained. The sheet S is further conveyed downstream and accumulated in the stock section 22.

The sections provided in the fibrous body manufacturing apparatus 100 explained above are electrically coupled to the control device 28. Operations of the sections are controlled by the control device 28.

As illustrated in FIG. 1, the control device 28 includes a control section 281, a storage section 282, and a communication section 283.

The control section 281 includes at least one processor and executes various programs stored in the storage section 282. As the processor, for example, a central processing unit (CPU) can be used. The control section 281 has various functions including a function of controlling driving of device sections relating to sheet manufacturing such as a function of controlling driving of the blower 261 in the fibrous body manufacturing apparatus 100.

For example, a program concerning sheet manufacturing is stored in the storage section 282.

The communication section 283 includes, for example, an I/O interface and communicates with the sections of the fibrous body manufacturing apparatus 100. The communication section 283 has, for example, a function of communicating with a computer or a server not illustrated in the figures via a network.

The control device 28 may be built in the fibrous body manufacturing apparatus 100 or may be provided in an external device such as an external computer. For example, the control section 281 and the storage section 282 may be integrated and configured as one unit, the control section 281 may be built in the fibrous body manufacturing apparatus 100 and the storage section 282 may be provided in the external device such as the external computer, or the storage section 282 may be built in the fibrous body manufacturing apparatus 100 and the control section 281 may be provided in the external device such as the external computer.

Next, the purification device 3 is explained.

As illustrated in FIGS. 2, 3, and 4, the purification device 3 is a device that gathers the powder H (the waste powder) sucked by the suction section 153 and the suction section 193 and includes a housing 4 and a filter unit 5 that is an example of a filter unit of the present disclosure.

As use (an operation) of the purification device 3 continues, the powder H gradually adheres to the outer surfaces, in particular, the outer circumferential portions of the filter members 51 to 54 provided in the filter unit 5. When an adhesion amount of the powder H increases, clogging occurs in the filter members 51 to 54 and a function of capturing the powder H sometimes deteriorates. For this reason, the operation of the purification device 3 or the like or the operation of the entire fibrous body manufacturing apparatus 100 is temporarily stopped and the filter members 51 to 54 on the inside are taken out and cleaned or replaced as explained below. Hereinafter, this work is also referred to as maintenance work. In the present disclosure, the maintenance work can be easily and quickly performed. Hereinafter, the sections are explained in detail.

As illustrated in FIGS. 2 and 3, the housing 4 separates air and the powder H from an airflow containing the transferred powder H, gathers the powder H, and stores the powder H in a lower part. The housing 4 includes a first inlet 41 and a second inlet 42 for introducing the powder H and the air and exhaust ports 43 for discharging the air.

The housing 4 includes a box, the exterior of which is formed in a substantially rectangular parallelepiped, and includes a housing main body 4A and a lid member 4B.

The housing main body 4A includes a top plate 401, a bottom plate 402, and four side walls 403, 404, 405, and 406. The side walls 403, 404, 405, and 406 are erected from edge portions of the bottom plate 402. The top plate 401 is provided on the side opposite to the bottom plate 402 of the side walls 403, 404, 405, and 406.

The top plate 401 is located on the +z-axis side. The bottom plate 402 is located on the -z-axis side. The side wall 403 is located on the +x-axis side. The side wall 404 is located on the -x-axis side. The side wall 405 is located on the +y-axis side. The side wall 406 is located on the -y-axis side. The side wall 403 and the side wall 404 face each other and the side wall 405 and the side wall 406 face each other. A portion surrounded by the top plate 401, the bottom plate 402, and the four side walls 403, 404, 405, and 406 is the first suction chamber A1.

As illustrated in FIG. 4, four exhaust ports 43 are provided in the top plate 401. The exhaust ports 43 are provided side by side to be spaced apart from one another along the y-axis direction. The filter members 51 to 54 explained below are installed in the exhaust ports 43 to communicate with the exhaust ports 43 one by one.

The first inlet 41 and the second inlet 42 are provided in the side wall 404. The first inlet 41 and the second inlet 42 are disposed side by side to be spaced apart from the +y-axis side in this order. The first inlet 41 is located at the center in the y-axis direction of the side wall 404. The second inlet 42 is located near the side wall 406. That is, the second inlet 42 is provided at a position deviating further to the -y-axis side than the center in the y-axis direction of the side wall 404.

The pipe 245 is coupled to the first inlet 41. The first inlet 41 introduces the powder H and the air sucked by the suction section 153 into the housing 4. The pipe 246 is coupled to the second inlet 42. The second inlet 42 introduces the powder H and the air sucked by the suction section 193 into the housing 4.

Opening surfaces of the first inlet 41 and the second inlet 42 are parallel to a y-z plane.

The first inlet 41 and the second inlet 42 are respectively formed in circular shapes and have the same opening area. However, without being limited to this configuration, the first inlet 41 and the second inlet 42 may be formed in another shape such as a rectangular shape, a polygonal shape, and an elliptical shape. The first inlet 41 and the second inlet 42 may be different in an opening shape or may be different in an opening area.

As explained above, the first inlet 41 and the second inlet 42 are disposed side by side in the side wall 404, that is, in one wall section. Accordingly, by consolidating the first inlet 41 and the second inlet 42 in one side wall 404, it is possible to simplify routing of pipes around the housing 4, particularly, the pipes 245 and 246. Accordingly, it is possible to contribute to a reduction in the size of the entire purification device 3.

As illustrated in FIGS. 2 to 5, an access port 407 is provided in the side wall 406. That is, the access port 407 is provided in a wall section on the -y-axis side of the housing 4. The access port 407 is a portion for inserting and removing (detaching) the filter unit 5 explained below.

An opening and closing door 408 is installed in the access port 407. An operator can insert and remove the filter unit 5 by opening the opening and closing door 408. An opening and closing type of the opening and closing door 408 may be a detachable type illustrated in the figures or another type such as a slide type, a single-opening type, or a double-opening type.

The housing main body 4A may be formed by assembling split bodies that can be vertically divided. In this case, the split bodies are separated to be vertically divided and the powder H in the housing main body 4A can be taken out and discarded.

The lid member 4B covers at least a part of the top plate 401 and is formed in a box shape having an opening opened to the -z-axis side. The lid member 4B is disposed in a direction in which an edge portion of the opening is in contact with the top plate 401. The lid member 4B has a function of collecting, from the housing main body 4A side, air having passed through the filter unit 5 and discharging the air to an exhaust pipe 247. The inner side of the lid member member 4B second suction chamber A2.

The lid member 4B has a connection port 409 to which the exhaust pipe 247 is coupled and a window section 410 for visually recognizing the inside of the second suction chamber A2. The connection port 409 is provided in a wall section on the +y-axis side in the lid member 4B. An end portion of the exhaust pipe 247 coupled to the connection port 409 is disposed on the upper side of the housing main body 4A and extends to the outer side of the fibrous body manufacturing apparatus 100, although not illustrated.

As illustrated in FIG. 5, the window section 410 is for the operator to visually recognize, preferably, to view the inside of the second suction chamber A2 and, in the present embodiment, includes a through hole. Here, "view" means that there is no obstacle and every corner of the inside of the second suction chamber A2 can be visually recognized.

The window section 410 is provided in a wall section on the -y-axis side in the lid member 4B. That is, the window section 410 is provided, in the lid member 4B, in a wall section on a side where the access port 407 is provided. In other words, the window section 410 is provided, in the lid member 4B, in a wall section on a side where the filter unit 5 is inserted into the housing 4. Accordingly, a standing position of the operator who looks into the window section 410 or replaces the filter unit 5 can be limited to the side wall 406 side. Thus, the work efficiency of the operator can be improved and a space around the purification device 3 (on the side of the side wall 403, the side wall 404, and the side wall 405) can be effectively used.

An opening and closing door 411 is installed in the window section 410. By opening the opening and closing door 411, the inside of the window section 410 can be visually recognized and the operator can clean the inside of the second suction chamber A2. An opening and closing type of the opening and closing door 411 is not particularly limited and may be a detachable type illustrated in the figures, a slide type, a single-opening type, a double-opening type, or the like. The opening and closing door 411 may be omitted. A light transmissive member, through which the inside of the second suction chamber A2 is visually recognizable, is preferably installed in the window section 410. Accordingly, it is possible to visually recognize the inside of the second suction chamber A2 while omitting opening and closing work.

As explained above, the housing 4 includes the window section 410 through which the inside of the second suction chamber A2 is visually recognized. Accordingly, it is possible to check whether foreign matters, in particular, the powder H is present in the second suction chamber A2. Thus, cleaning, maintenance, and the like in the second suction chamber A2 can be performed according to necessity.

The window section 410 may be omitted.

The window section 410 is provided in a wall section on a side where the filter unit 5 is inserted into the housing 4. Accordingly, the work efficiency of the operator can be improved and a space around the purification device 3 can be effectively used.

The window section 410 and the access port 407 may be provided in wall sections located in directions different from each other.

Four compressed air supplying sections 413 are coupled to the lid member 4B. The compressed air supplying sections 413 are installed on a wall section on the +z-axis side of the lid member 4B. The compressed air supplying sections 413 supply compressed air. The distal end portions thereof are located on the inside of the lid member 4B and inject the compressed air toward the -z-axis side.

The compressed air supplying sections 413 are respectively disposed at positions corresponding to the filter members 51 to 54 and have a function of removing, from the filter members 51 to 54, the powder H adhering to the outer circumferential portions of the filter members 51 to 54. Accordingly, a cleaning frequency of the filter members 51 to 54 can be reduced.

Next, the filter unit 5 is explained.

The filter unit 5 includes a plurality of (four in the present embodiment) filter members 51 to 54 formed in a cylindrical shape and a support member 55 that is in close contact with (without a gap) and supports the outer circumferential portions of the filter members 51 to 54. The filter unit 5 is detachably installed in the housing 4.

Hereinafter, the filter members 51 to 54 are explained. However, since these have the same configuration, the filter member 51 is representatively explained.

As illustrated in FIGS. 3 and 4, the filter member 51 is formed in a bottomed cylindrical shape including an opening 50 at one end portion (the upper end portion) and is installed such that the opening 50 faces the second suction chamber A2 side. The inside of the filter member 51 may be regarded as a part of the second suction chamber A2.

The filter members 51 to 54 are formed in a bottomed cylindrical shape including the openings 50 and are supported by the support member 55 in a state in which the openings 50 face the +z-axis side, that is, the same direction. Accordingly, replacement work for the filter members 51 to 54 can be more quickly performed.

The filter member 51 includes a bottomed cylindrical filter main body 510 and an enlarged diameter section 511 provided at the end portion on the opening 50 side of the filter main body 510.

The filter member 51 has a function of allowing passage of air and preventing passage of the powder H, that is, gathering the powder H. As the filter member 51, for example, a fine mesh body (a mesh), woven fabric, nonwoven fabric, or any combination thereof can be used.

The outer circumferential surface of the filter member 51 may be made of a material to which the powder H less easily adheres or from which the powder H easily separates or may be subjected to surface treatment to make the powder H less easily adhere to or easily separate from the outer circumferential surface. Accordingly, it is possible to more effectively prevent or suppress clogging of the filter member 51 due to the powder H. Thus, a frequency of cleaning work for the filter member 51 can be reduced.

In the present embodiment, the outer diameters and the lengths in the z-axis direction of the four filter members 51 to 54 are substantially equal. However, without being limited thereto, any one of the filter members 51 to 54 may be different in the shape, the material, and dimensions such as the outer diameter and the length thereof from the other filter members.

In the present embodiment, the filter members 51 to 54 are respectively the same in outer diameters and cross-sectional shapes over the entire length in the z-axis direction. However, not only this, but different parts may be present along the z-axis direction. For example, in a part in the z-axis direction, there may be portions where the outer diameters or the cross-sectional shapes of the filter members 51 to 54 are different from those of other parts.

The support member 55 is formed in a plate shape including four installation holes 550 in which the filter members 51 to 54 are respectively installed. The installation holes 550 include through holes disposed apart from one another. The installation holes 550 have substantially the same outer diameter as the filter main bodies 510 of the filter members 51 to 54 and are smaller than the enlarged diameter sections 511 of the filter members 51 to 54. Accordingly, when the filter members 51 to 54 are inserted through the installation holes 550, the enlarged diameter sections 511 are caught by edge portions of the installation holes 550. In this state, the support member 55 can be in close contact with and support the outer circumferential portions of the filter members 51 to 54.

Note that "in close contact with and supports" is a state in which the outer circumferential portions of the filter main bodies 510 of the filter members 51 to 54 and the inner circumferential portions of the installation holes 550 are in contact over the entire circumferences and means that a gap through which the powder H and the like pass is absent therebetween. That is, at the time of normal use, the air, the powder H, and the like do not shift from the first suction chamber A1 to the second suction chamber A2 from between the outer circumferential portions of the filter main bodies 510 of the filter members 51 to 54 and the inner circumferential portions of the installation holes 550.

The inner side of the filter members 51 to 54 communicates with the second suction chamber A2 and the outer side of the filter members 51 to 54 is the first suction chamber A1. Accordingly, the first suction chamber A1 can be divided as a space in which the powder H is present and the second suction chamber A2 can be divided as a clean space.

In addition, since the support member 55 is configured to collectively support the filter members 51 to 54, the filter members 51 to 54 can be collectively inserted into and taken out from the housing 4. Thus, the filter members 51 to 54 can be, for example, easily and quickly replaced and cleaned.

Although not illustrated, suction sources may or may not be coupled to the exhaust ports 43. When the suction sources are coupled to the exhaust ports 43, dedicated suction sources may be coupled to the exhaust ports 43 or one suction source may suck the exhaust ports 43. When the suction sources explained above are coupled, the powder H can be more smoothly and efficiently gathered.

A part of the powder H introduced from the first inlet 41 and a part of the powder H introduced from the second inlet 42 are captured by the filter members 51 to 54. The remaining part flies in the housing 4 and thereafter falls downward and is deposited on the bottom portion of the housing 4. The powder H captured by the filter members 51 to 54 and adhering to the surfaces is also separated from the filter members 51 to 54, falls, and is deposited on the bottom portion in the housing 4. The air introduced from the first inlet 41 and the air introduced from the second inlet 42 pass through the filter members 51 to 54 and are discharged from the exhaust ports 43 through the inner cavities of the filter members 51 to 54.

As explained above, since the powder H caused in the first web forming section 15 and the powder H caused in the second web forming section 19 are gathered by one purification device 3, it is possible to simplify a device configuration and to achieve a reduction in the size of the entire fibrous body manufacturing apparatus 100 as compared with a configuration in which a dedicated purification device is coupled to each of the first web forming section 15 and the second web forming section 19.

Next, the rail section 6 is explained.

As illustrated in FIGS. 5-10, the rail section 6 has a function of guiding the support member 55 when the filter unit 5 is installed in the housing 4 and when the filter unit 5 is detached from the housing 4. The rail section 6 has a function of stably supporting the support member 55 of the filter unit 5 in a mounted state in which the filter unit 5 is installed in the housing 4. In the mounted state, the filter unit 5 partitions the first suction chamber A1 and the second suction chamber A2 explained below.

As illustrated in FIG. 5, the rail section 6 includes a rail member 61 that is in contact with the inner surface of the wall section in the housing main body 4A, a rail member 62 that is in contact with the inner surface of the wall section, and a coupling plate 63 that couples the rail member 61 and the rail member 62. A pair of claw sections 412 by which hooks 711 of a lock member 71 explained below are caught is provided at the end portion on the -y-axis side of the rail section 6.

The rail member 61 includes a plate-shaped section 611 fixed to the inner surface (the surface on the +x-axis side) of the side wall 404 and a guide section 612 provided at the edge portion on the -z-axis side of the plate-shaped section 611 and provided to protrude to the inner side of the housing main body 4A.

The plate-shaped section 611 is fixed to a portion on the +z-axis side in the side wall 404 and extends in the y-axis direction. The guide section 612 has a function of coming into contact with the support member 55 and guiding the filter unit 5 when the operator attaches or detaches the filter unit 5 to or from the housing 4. The guide section 612 has a function of supporting the support member 55 and the filter unit 5 in the mounted state.

An end portion (the terminal end portion) on the +y-axis side of the plate-shaped section 611 is bent to be closer to the +z-axis side toward the +y-axis side. This portion is a bent portion 613.

The rail member 62 includes a plate-shaped section 621 fixed to the side wall 403 and a guide section 622 provided at the edge portion on the -z-axis side of the plate-shaped section 621 and provided to protrude to the inner side of the housing main body 4A.

The plate-shaped section 621 is fixed to a portion on the +z-axis side in the side wall 403 and extends in the y-axis direction. The guide section 622 has a function of coming into contact with the support member 55 and guiding the support member 55 when the operator attaches or detaches the filter unit 5 to or from the housing 4. The guide section 622 has a function of supporting the support member 55 and the filter unit 5 in the mounted state.

The end portion (the terminal end portion) on the +y-axis side of the plate-shaped section 621 is bent to be closer to the +z-axis side toward the +y-axis side. This portion is a bent portion 623.

The coupling plate 63 is fixed to the surface on the -z-axis side of the top plate 401. The coupling plate 63 is formed in a shape that does not close the exhaust port 43 of the top plate 401. That is, the coupling plate 63 has an opening including the exhaust port 43 of the top plate 401.

Next, the lock mechanism 7 is explained.

As illustrated in FIGS. 5 to 8, the lock mechanism 7 has a function of maintaining the mounted state. The lock mechanism 7 includes the bent portion 613 provided in the guide section 612, the bent portion 623 provided in the guide section 622, the guide section 64, and the lock member 71.

When bringing the filter unit 5 into the mounted state, the operator inserts the filter unit 5 from the access port 407 and pushes the filter unit 5 to the +y-axis side. When the pushing of the support member 55 is completed, the end portion on the +y-axis side and on the -x-axis side of the support member 55 shifts to the +z-axis side along the bent portion 613 and the end portion on the +y-axis side and on the +x-axis side of the support member 55 shifts to the +z-axis side along the bent portion 623. Accordingly, the support member 55 is pressed against the top plate 401 and the mounted state can be more stably maintained.

As illustrated in FIGS. 5 to 8, the guide section 64 includes a protruding portion 641 that is the end portion on the +y-axis side of the plate-shaped section 611 and protrudes to the +x-axis side and a protruding portion 642 that is the end portion on the +y-axis side of the plate-shaped section 621 and protrudes to the -x-axis side.

The protruding portion 641 and the protruding portion 642 respectively include inclined surfaces 640 inclined in the same direction as the bent portion 613 and the bent portion 623. When the filter unit 5 is brought into the mounted state, the end portion on the +y-axis side of the support member 55 is guided to the +y-axis side and the +z-axis side by the inclined surface 640. At this time, the support member 55 shifts from a state in which the support member 55 is guided by the bent portion 613 and the bent portion 623 to a state in which the support member 55 is guided by the inclined surfaces 640 as illustrated in FIG. 11 and, finally, the support member 55 climbs up to the terminal end of the inclined surface 640 as illustrated in FIG. 12. Accordingly, the support member 55 is pressed to the second suction chamber A2 side. Thus, the mounted state can be more stably maintained.

When the filter unit 5 is removed from the mounted state, the support member 55 is pulled to the -y-axis side. Then, contrary to the above, the support member 55 is guided by the inclined surface 640, moves to the -y-axis side and the -z-axis side, and shifts to the bent portion 613 and the bent portion 623. The support member 55 moves to the -y-axis side while being guided by the guide section 612 and the guide section 622.

The lock member 71 is a so-called arm catch type. In a state in which the pushing of the support member 55 is completed, the lock member 71 is located immediately below the claw sections 412 of the rail section 6. By lowering the lever 712 in a state in which the hook 711 is caught by the claw sections 412 of the rail section 6, the hook 711 is caught by the claw sections 412 to be locked, and the mounted state can be suitably maintained.

The lock member 71 is not limited to the configuration explained above and may be of another type such as a catch latch type or a magnet type.

As explained above, the purification device 3 further includes the lock mechanism 7 that maintains the mounted state. Accordingly, the mounted state can be suitably maintained.

The lock mechanism 7 may be omitted.

The lock mechanism 7 presses the filter unit 5 to the second suction chamber A2 side in the mounted state. Accordingly, the mounted state can be more suitably maintained.

The lock mechanism 7 includes the bent portion 613 in which the terminal end portion (the end portion on the +y-axis side) of the guide section 612 provided in the rail section 6 is bent to the second suction chamber A2 side and the bent portion 623 in which the terminal end portion (the end portion on the +y-axis side) of the guide section 622 provided in the rail section 6 is bent to the second suction chamber A2 side. Accordingly, the support member 55 can be pressed to the second suction chamber A2 side and the mounted state can be more stably maintained.

As explained above, the purification device 3 includes the housing 4 including the first suction chamber A1 and the second suction chamber A2, the filter unit 5 including the plurality of filter members 51 to 54 formed in the cylindrical shape and the support member 55 that is in close contact with and supports the outer circumferential portions of the filter members 51 to 54, the filter unit 5 being detachably installed in the housing 4, the rail section 6 that guides the support member 55 when the filter unit 5 is installed in the housing 4 and when the filter unit 5 is detached from the housing 4, and the blowers 262 and 263 serving as the airflow generation sections that generate an airflow that causes the air in the first suction chamber A1 to flow to the second suction chamber A2 side via the filter members 51 to 54, and the filter unit 5 partitions the first suction chamber A1 and the second suction chamber A2 in the mounted state in which the filter unit 5 is installed in the housing 4.

In the purification device 3 explained above, since the support member 55 is configured to collectively support the filter members 51 to 54, the filter members 51 to 54 can be collectively inserted into and taken out from the housing 4. Thus, the filter members 51 to 54 can be, for example, easily and quickly replaced and cleaned.

The filter unit 5 is detachably installed in the housing 4 of the purification device 3 including the housing 4 including the first suction chamber A1 and the second suction chamber A2, the rail section 6 provided in the housing 4, and the blowers 262 and 263 serving as the airflow generation sections that generate an airflow that causes the air in the first suction chamber A1 to flow to the second suction chamber A2 side, the filter unit 5 including the plurality of filter members 51 to 54 formed in the cylindrical shape and the support member 55 that is in close contact with and supports the outer circumferential portions of the filter members 51 to 54, in the mounted state in which the filter unit 5 is installed in the housing 4, the filter unit 5 partitioning the first suction chamber A1 and the second suction chamber A2.

In the filter unit 5 explained above, since the support member 55 is configured to collectively support the filter members 51 to 54, the filter members 51 to 54 can be collectively inserted into and taken out from the housing 4. Thus, the filter members 51 to 54 can be, for example, easily and quickly replaced and cleaned.

In the present embodiment, the filter members 51 to 54 are formed in the cylindrical shape. However, in the present disclosure, without being limited thereto, the filter members 51 to 54 may be formed in a rectangular cylindrical shape.

In the present embodiment, the four filter members 51 to 54 are provided. However, in the present disclosure, without being limited thereto, one to three or five or more filter members may be provided.

The filter members 51 to 54 are not limited to be disposed in one row as illustrated in the figures and may be disposed in two or more rows or may be disposed in a staggered manner.

The filter members 51 to 54 may not be disposed in parallel as illustrated in the figures.

The filter members 51 to 54 are formed in the bottomed cylindrical shape having the openings 50 and are supported by the support member 55 in a state in which the openings 50 face the same direction. Accordingly, replacement work for the filter members 51 to 54 can be more quickly performed.

In the mounted state, the inner side of the filter members 51 to 54 communicates with the second suction chamber A2 and the outer side of the filter members 51 to 54 is the first suction chamber A1. Accordingly, the first suction chamber A1 can be divided as a space in which the powder H is present and the second suction chamber A2 can be divided as a clean space. Thus, maintenance such as cleaning for the purification device 3 can be more easily performed.

Next, an example of a production method for a purification device of the present disclosure is explained.

The production method for the purification device of the present disclosure includes a first step, a second step, and a third step.

### First Step

A first step is a step of taking out, along the rail section 6, the filter unit 5 to which the powder H serving as foreign matters adheres. Specifically, first, the opening and closing door 408 of the access port 407 is opened and the lever 712 of the lock member 71 is lowered to unlock the hook 711 from the claw sections 412 of the rail section 6. Subsequently, the support member 55 is pulled to the -y-axis side via the access port 407. Accordingly, the support member 55 is guided by the inclined surface 640 to move to the -y-axis side and the -z-axis side and shift to the bent portion 613 and the bent portion 623. The support member 55 moves to the -y-axis side while being guided by the guide section 612 and the guide section 622. The filter unit 5 can be taken out from the access port 407.

In the first step, since the support member 55 is guided by the rail section 6, the filter unit 5 can be easily and stably taken out.

### Second Step

A second step is a step of cleaning the taken-out filter unit 5. The cleaning in this step is performed by tapping off the powder H adhering to the filter members 51 to 54, sucking the powder H adhering to the filter members 51 to 54, or replacing the filter members 51 to 54 to which the powder H adheres with new filter members 51 to 54.

### Third Step

A third step is a step of inserting the cleaned filter unit 5 along the rail section 6 and mounting the filter unit 5 in the housing 4.

In the third step, the filter unit 5 is inserted from the access port 407 and pushed to the +y-axis side. At this time, as illustrated in FIGS. 9 and 10, since the support member 55 is guided by the rail section 6, the filter unit 5 can be easily and stably mounted. When the pushing of the support member 55 is completed, the end portion on the +y-axis side and on the -x-axis side of the support member 55 shifts to the +z-axis side along the bent portion 613 and the end portion on the +y-axis side and on the +x-axis side of the support member 55 shifts to the +z-axis side along the bent portion 623. Accordingly, the support member 55 is pressed against the top plate 401 and the mounted state can be more stably maintained.

Then, by lowering the lever 712 in a state in which the hook 711 of the lock member 71 is caught by the claw sections 412 of the rail section 6, the hook 711 is caught by the claw sections 412 to be locked. Accordingly, the mounted state can be suitably maintained.

As explained above, the production method for the purification device 3 is the production method of producing the purification device 3 cleaned by cleaning the purification device 3 including the housing 4 including the first suction chamber A1 and the second suction chamber A2, the filter unit 5 including the plurality of filter members 51 to 54 formed in the cylindrical shape and the support member 55 that is in close contact with and supports the outer circumferential portions of the filter members 51 to 54, the filter unit 5 being detachably installed in the housing 4, the rail section 6 that guides the support member 55 when the filter unit 5 is installed in the housing 4 and when the filter unit 5 is detached from the housing 4, and the blowers 262 and 263 serving as the airflow generation sections that generate an airflow that causes the air in the first suction chamber A1 to flow to the second suction chamber A2 side via the filter members 51 to 54, the filter unit 5 partitioning the first suction chamber A1 and the second suction chamber A2 in the mounted state in which the filter unit 5 is installed in the housing 4, the production method including a first step of taking out, along the rail section 6, the filter unit 5 to which foreign matters adhere, a second step of cleaning the taken-out filter unit 5, and a third step of inserting the cleaned filter unit 5 along the rail section 6 to mount the filter unit 5 in the housing 4.

Accordingly, since the support member 55 is configured to collectively support the filter members 51 to 54, the filter members 51 to 54 can be collectively inserted into and taken out from the housing 4. Thus, the filter members 51 to 54 can be, for example, easily and quickly replaced and cleaned.

Although the purification device, the filter unit, and the production method for the purification device of the present disclosure are explained above about the illustrated embodiment, the present disclosure is not limited thereto, and the sections and the steps configuring the purification device, the filter unit, and the production method for the purification device can be replaced with sections and steps having any configurations that can exert the same functions. Any components and any steps may be added to the purification device, the filter unit, and the production method for the purification device.

What is claimed is:

1. A purification device comprising:
a housing including a first suction chamber and a second suction chamber;
a filter unit including a plurality of filter members formed in a cylindrical shape and a support member that is in close contact with and supports outer circumferential portions of the filter members, the filter unit being detachably installed in the housing;
a rail section configured to guide the support member when the filter unit is installed in the housing and when the filter unit is detached from the housing; and
an airflow generation section configured to generate an airflow that causes air in the first suction chamber to flow to the second suction chamber side via the filter members, wherein
the filter unit partitions the first suction chamber and the second suction chamber in a mounted state in which the filter unit is installed in the housing.

2. The purification device according to claim 1, further comprising a lock mechanism configured to maintain the mounted state.

3. The purification device according to claim 2, wherein the lock mechanism presses the filter unit to the second suction chamber side in the mounted state.

4. The purification device according to claim 3, wherein the lock mechanism includes a bent portion in which a terminal end portion of the rail section is bent to the second suction chamber side.

5. The purification device according to claim 1, wherein the housing includes a window section through which an inside of the second suction chamber is visually recognized.

6. The purification device according to claim 5, wherein the window section is provided in a wall section on a side where the filter unit is inserted into the housing.

7. The purification device according to claim 1, wherein the filter members are formed in a bottomed cylindrical shape having openings and are supported by the support member in a state in which the openings face a same direction.

8. The purification device according to claim 1, wherein, in the mounted state, an inner side of the filter members communicates with the second suction chamber and an outer side of the filter members is the first suction chamber.

9. A filter unit detachably installed in a housing of a purification device including:
the housing including a first suction chamber and a second suction chamber;
a rail section provided in the housing; and
an airflow generation section configured to generate an airflow that causes air in the first suction chamber to flow to the second suction chamber side,
the filter unit comprising:
a plurality of filter members formed in a cylindrical shape; and
a support member that is in close contact with and supports outer circumferential portions of the filter members, wherein
the filter unit partitions the first suction chamber and the second suction chamber in a mounted state in which the filter unit is installed in the housing.

10. A production method of producing a purification device cleaned by cleaning the purification device including:
a housing including a first suction chamber and a second suction chamber;
a filter unit including a plurality of filter members formed in a cylindrical shape and a support member that is in close contact with and supports outer circumferential portions of the filter members, the filter unit being detachably installed in the housing;
a rail section configured to guide the support member when the filter unit is installed in the housing and when the filter unit is detached from the housing; and
an airflow generation section configured to generate an airflow that causes air in the first suction chamber to flow to the second suction chamber side via the filter members,
the filter unit partitioning the first suction chamber and the second suction chamber in a mounted state in which the filter unit is installed in the housing,
the production method comprising:
a first step of taking out, along the rail section, the filter unit to which foreign matters adhere;
a second step of cleaning the taken-out filter unit; and
a third step of inserting the cleaned filter unit along the rail section and mounting the filter unit in the housing.
